(19) United States
(12) Patent Application Publication
(10) Pub. No.: US 2012/0008210 A1
(43) Pub. Date: Jan. 12, 2012

(54) DIFFRACTIVE LENS AND IMAGE CAPTURE DEVICE USING THE SAME

(75) Inventors: Tsuguhiro Korenaga, Osaka (JP); Takamasa Ando, Osaka (JP)

(73) Assignee: PANASONIC CORPORATION, Osaka (JP)

(21) Appl. No.: 13/257,376

(22) PCT Filed: Feb. 23, 2011
(86) PCT No.: PCT/JP2011/001018

§ 371 Date: Sep. 19, 2011

(30) Foreign Application Priority Data
Feb. 26, 2010 (JP) 2010-041503

(51) Int. Cl. G02B 5/18

(52) U.S. Cl. 359/570; 359/571

(57) ABSTRACT

The present invention reduces the angle dependence of diffraction efficiency by taking the diffraction pitch and diffraction step of an optical element with a diffraction grating such as a lens into account. Specifically, for that purpose, an optical element that has a first group of diffraction grating portions 20 around an optical axis 10 is covered with a protective coating 14, and a second group of diffraction grating portions 21 are arranged on the surface of the protective coating 14 far away from the optical axis 10.

### TECHNICAL FIELD

The present invention relates to a diffractive lens that realizes high resolution in a wide angle range by minimizing production of unnecessary diffracted light and loss of light, and also relates to an image capture device that uses such a lens.

### BACKGROUND ART

A diffractive lens, which has a concentric diffraction grating portion on the surface of an aspheric lens, is known as a lens that would realize higher image capturing performance than an aspheric lens. By achieving not just the refraction effect of an aspheric lens but also diffraction effect, a diffractive lens can reduce significantly various kinds of aberrations such as chromatic aberration and field curvature. Particularly with a diffraction grating portion, of which the cross section is either blazed or consisting of fine steps that are inscribed to each other in a blazed pattern, the diffraction efficiency of a particular order with respect to a single wavelength can be increased to almost 100%.

Suppose a blazed diffraction grating portion 92 has been formed on the surface of a base 91 with a refractive index n(λ) as shown in FIG. 9. The diffraction step d of a diffraction grating portion, of which the m^{th}-order diffraction efficiency (where m is an integer) becomes 100% theoretically with respect to a light ray 93 that has been incident thereon perpendicularly with a wavelength λ, is calculated by the following Equation (1):

d=mλ/(n(λ)−1) (1)

where the refractive index n(λ) indicates that the refractive index is a function of wavelength.

As can be seen from this Equation (1), as the wavelength λ varies, the d value that makes the m^{th}-order diffraction efficiency 100% also varies. Although the diffraction efficiency is supposed to be of the first-order (i.e., m=1) in the following example, m is not always one.

FIG. 10 shows the first-order diffraction efficiency of a light ray that has been incident perpendicularly onto a diffraction grating portion of polycarbonate that has a diffraction step of 0.93 μm. Since the diffraction step d of the diffraction grating portion has been determined by substituting a wavelength of 550 nm into Equation (1), the diffraction efficiency of the first-order diffracted ray becomes almost 100% at a wavelength of 550 nm. The first-order diffraction efficiency has wavelength dependence, and therefore, decreases to approximately 50% at a wavelength of 400 nm. Once the first-order diffraction efficiency has declined from 100%, unnecessary diffracted rays, including zero-order, second-order and minus-first-order ones, are produced.

However, if light falling within the entire visible radiation range (i.e., in the wavelength range of 400 nm through 700 nm) is made to be incident on an aspheric diffractive lens, on which a diffraction grating portion such as the blazed one shown in FIG. 9 has been formed concentrically, the resultant color image will have a lot of noticeable flare. Such a flare is caused by unnecessary diffracted rays other than the first-order one that should be used for producing a subject image. Among other things, the bigger the difference in luminance between the subject and the background, the more noticeable the flare will be.

When such a flare is produced, the diffraction grating shown in FIG. 9 can be used to capture an image in only limited situations. Specifically, in that case, the diffraction grating can be used only when the luminance of a subject to shoot is not as high as that of the background or when the resolution does not have to be high, for instance. That is why it cannot be said that the conventional technique has fully developed the potential of a diffraction grating, of which the image capturing performance could be much higher than that of an aspheric lens, were it used more appropriately.

To produce a color image with little flare using such a diffractive lens, somebody proposed a technique for reducing the wavelength dependence of the diffraction efficiency of a particular order (see Patent Document No. 1, for example). FIG. 11 illustrates a diffractive optical element as disclosed in Patent Document No. 1, which teaches applying and bonding a protective coating 113 that covers a diffraction grating portion 112 on a base 111.

In that case, the diffraction step d′ of the diffraction grating portion that makes 100% the first-order diffraction efficiency of a light ray striking the diffraction grating portion 112 perpendicularly (i.e., at an angle of incidence θ of zero degrees) is given by the following Equation (2):

d′=mλ/|n₁(λ)−n₂(λ)| (2)

In Equation (2), λ is the wavelength, m is the order of diffraction, n₁(λ) is the refractive index of the base material, and n₂(λ) is the refractive index of the protective coating material. If the right side of Equation (2) becomes constant in a certain wavelength range, the m^{th}-order diffraction efficiency no longer has wavelength dependence in that wavelength range. Such a condition is satisfied if the base and the protective coating are made of an appropriate combination of a high-refractive-index, high-Abbe-number material and a low-refractive-index, low-Abbe-number material. By making the base and the protective coating of such appropriate materials, the diffraction efficiency with respect to perpendicularly incident light can be 95% or more in the entire visible radiation range. It should be noted that in this configuration, the materials of the base and the protective coating could be changed with each other. Also, the height d′ of the diffraction step of the diffraction grating portion becomes greater than the height d of the diffraction step of the diffraction grating portion with no protective coating to be calculated by Equation (1).

The diffractive lens shown in FIG. 11 produces only a few unnecessary diffracted rays other than the first-order one, and therefore, will hardly cause a flare that is a problem with the diffractive lens shown in FIG. 9. As a result, a good image can be produced with high resolution.

As can be seen, it is very effective to form the diffraction grating portion shown in FIG. 11 on the surface of an aspheric lens in order to produce an image with high resolution. In the following description, a diffractive lens to be used mainly for image capturing purposes will be referred to herein as a “diffractive imaging lens”.

### CITATION LIST

### Patent Literature

Patent Document No. 1: Japanese Patent Application Laid-Open Publication No. 9-127321

### SUMMARY OF INVENTION

### Technical Problem

However, the present inventors discovered via experiments that the diffractive imaging lens shown in FIG. 11 has the following drawback.

Specifically, if the diffractive imaging lens shown in FIG. 11 is used as a camera lens with a small angle of view (such as a telephoto lens), the resultant image will be much sharper than what is obtained with the diffractive imaging lens shown in FIG. 9. On the other hand, if the diffractive imaging lens shown in FIG. 11 is used as a wide-angle lens for a camera, a flare will be produced in the resultant image and the contrast of the image will decrease significantly. On top of that, if a peripheral part of an image with a large angle of view darkens, the difference in brightness will be considerable between the center and peripheral parts of that image.

It is therefore an object of the present invention to provide a diffractive lens that can minimize such a flare by reducing unnecessary diffracted rays and that will keep the brightness of an image high enough in its peripheral part even when used as a wide-angle lens and also provide an image capture device using such a lens.

### Solution to Problem

A diffractive lens according to the present invention includes a lens base, one surface of which has a first aspheric shape on which a first group of diffraction steps and a first smooth surface portion are arranged in this order outward from the optical axis of the diffractive lens, and a protective coating, which covers that surface of the lens base with the first group of diffraction steps and the first smooth surface portion and one surface of which has a second aspheric shape on which a second smooth surface portion and a second group of diffraction steps are arranged in this order outward from the optical axis of the diffractive lens. The second group of diffraction steps is arranged farther away from the optical axis, and lower in height, than the first group of diffraction steps. One of the respective materials of the lens base and the protective coating has a higher refractive index and a greater Abbe number than the other material.

Another diffractive lens according to the present invention is used to capture an image and includes a lens base, one surface of which has a first group of diffraction steps, and a protective coating, which covers that surface of the lens base with the first group of diffraction steps. The protective coating has, on its surface, a second group of diffraction steps, which is arranged farther away from the optical axis of the diffractive lens, and lower in height, than the first group of diffraction steps. One of the respective materials of the lens base and the protective coating has a higher refractive index and a greater Abbe number than the other material.

An image capture device according to the present invention includes an optical system including a diffractive lens, and a solid-state image sensor for converting light that has come from a subject and has passed through the optical system into an electrical signal. The diffractive lens includes a lens base, one surface of which has a first group of diffraction steps, and a protective coating, which covers that surface of the lens base with the first group of diffraction steps. The protective coating has, on its surface, a second group of diffraction steps, which is arranged farther away from the optical axis of the diffractive lens, and lower in height, than the first group of diffraction steps. One of the respective materials of the lens base and the protective coating has a higher refractive index and a greater Abbe number than the other material. And the solid-state image sensor receives, on the same image capturing plane, light rays that have been incident on the first and second groups of diffraction steps, respectively, and then converts the light rays into the electrical signal.

### Advantageous Effects of Invention

According to the present invention, the first-order diffraction efficiency of light that has been incident on the second group of diffraction steps can be increased. That is why a light ray that is going to enter a lens at a relatively large angle of incidence can have increased first-order diffraction efficiency, and unnecessary diffracted light rays, other than the first-order one, can be reduced.

Consequently, an image capture device that uses the diffractive lens of the present invention as a wide-angle lens can minimize a flare that would otherwise be caused due to the presence of those unnecessary diffracted light rays, and can prevent the contrast of the resultant image from decreasing. On top of that, the incoming light with such a large angle of incidence will cause so little loss that a peripheral part of the image can be bright enough.

### BRIEF DESCRIPTION OF DRAWINGS

FIG. 1 is a cross-sectional view illustrating a diffractive imaging lens 11 as a specific preferred embodiment of the present invention.

FIG. 2 shows the wavelength dependence of the first-order diffraction efficiency with respect to a light ray that has been incident perpendicularly onto the diffraction grating portions 20 of the first group.

FIG. 3 illustrates an image capture device that uses the diffractive imaging lens 11 of the preferred embodiment shown in FIG. 1.

FIG. 4 shows the chromatic aberration and the magnitude of field curvature of the two-lens imaging optical system shown in FIG. 3.

FIG. 5 illustrates a light ray that is passing through the diaphragm 32 and the diffractive imaging lens 11 in the image capture device shown in FIG. 3.

FIG. 6 shows the results of simulations that were carried out on a light ray that entered a diffractive imaging lens at an angle of incidence of 0 degrees to find how the first-order diffraction efficiency changed with the diffraction step height.

FIG. 7 shows the results of simulations that were carried out on a light ray that entered a diffractive imaging lens at an angle of incidence of 5 degrees to find how the first-order diffraction efficiency changed with the diffraction step height.

FIG. 8 shows the results of simulations that were carried out on a light ray that entered a diffractive imaging lens at an angle of incidence of 10 degrees to find how the first-order diffraction efficiency changed with the diffraction step height.

FIG. 9 illustrates a conventional diffraction grating portion.

FIG. 10 is a graph showing the wavelength dependence of the first-order diffraction efficiency in a conventional diffraction grating.

FIG. 11 illustrates a conventional diffraction grating portion covered with a protective coating.

### DESCRIPTION OF EMBODIMENTS

Hereinafter, preferred embodiments of a diffractive imaging lens and image capture device according to the present invention will be described with reference to the accompanying drawings. It should be noted, however, that the present invention is in no way limited to the specific preferred embodiments to be described below.

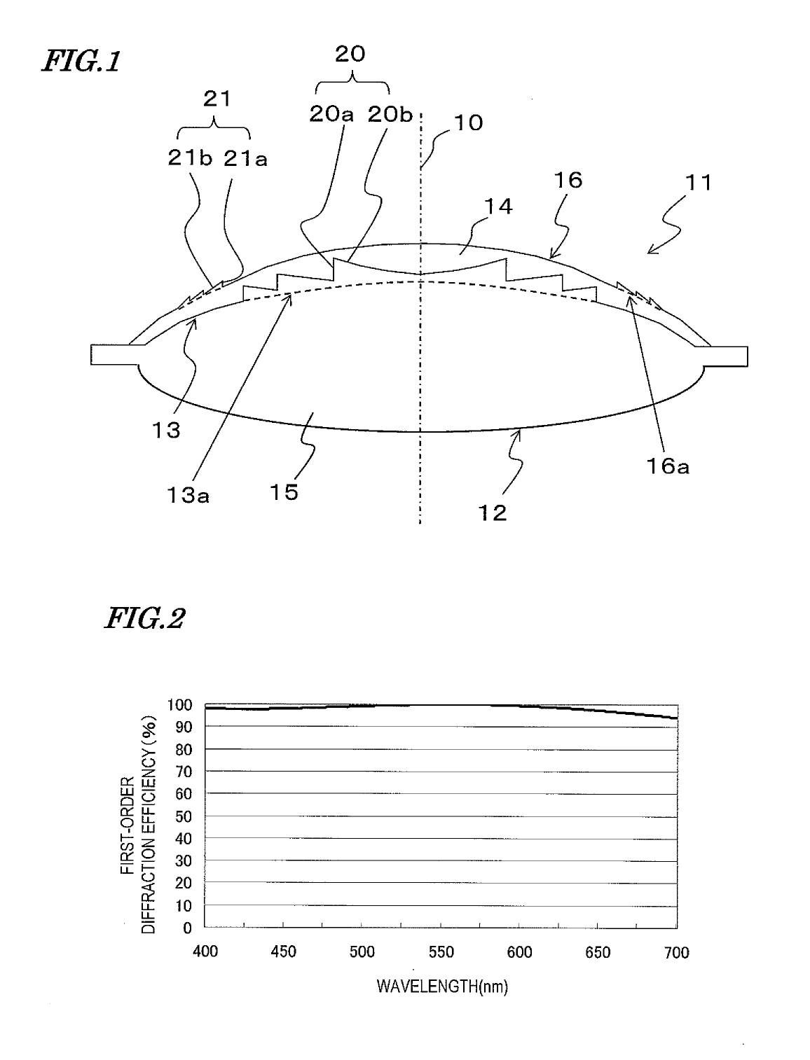

FIG. 1 is a cross-sectional view illustrating a diffractive imaging lens 11 as a specific preferred embodiment of the present invention. The diffractive imaging lens 11 of this preferred embodiment includes a lens base 15 and a protective coating 14. The lens base 15 has first and second aspheric surfaces 12 and 13. The first surface 12 will face toward the subject, while the second surface 13 will face away from the subject (i.e., face toward the place where the incoming light is imaged). And the second surface 13 has a first group of diffraction grating portions 20 with a concentric ring pattern in plan view. The protective coating 14 is arranged so as to cover the second surface of the lens base 15 and has a third surface 16 that faces toward the place where the incoming light is imaged. On the third surface 16, a second group of diffraction grating portions 21 with a concentric ring pattern is arranged farther away from the optical axis 10 than the first group of diffraction grating portions 20 is. In other words, the first group of diffraction grating portions 20 is located closer to the optical axis 10 than the second group of diffraction grating portions 21 is.

The first and second groups 20 and 21 each consists of a number of diffraction grating portions. Each diffraction grating portion 20 of the first group is comprised of a first surface (which is a diffractive step) 20a and a second surface 20b. The first surface 20a is arranged substantially parallel to the optical axis 10. On the other hand, the second surface 20b connects together the upper end of the first surface 20a of one diffraction grating portion 20 of the first group and the lower end of the first surface 20a of another diffraction grating portion 20 of the first group. The latter diffraction grating portion 20 is arranged inside of the former diffraction grating portion 20. And those diffraction steps defined by the respective first surfaces 20a are arranged concentrically around the optical axis.

In the same way, each diffraction grating portion 21 of the second group is also comprised of a first surface (which is a diffractive step) 21a and a second surface 21b. The first surface 21a is arranged substantially parallel to the optical axis 10. On the other hand, the second surface 21b connects together the upper end of the first surface 21a of one diffraction grating portion 21 of the second group and the lower end of the first surface 21a of another diffraction grating portion 21 of the second group. The latter diffraction grating portion 21 is arranged outside of the former diffraction grating portion 21. The second surface 20b of each diffraction grating portion 20 of the first group faces inward (i.e., toward the optical axis), whereas the second surface 21b of each diffraction grating portion 21 of the second group faces outward. And those diffraction steps defined by the respective first surfaces 21a are arranged concentrically around the optical axis.

Of two different materials for the base 15 of the diffractive imaging lens 11 and the protective coating 14, one material may have a higher refractive index and a lower degree of wavelength dispersion (i.e., a larger Abbe number) than the other. By using such a combination of materials with two different properties, d′ that maximizes the first-order diffraction efficiency becomes substantially constant irrespective of the operating wavelength. For example, suppose the base 15 and the protective coating 14 need to be made of a material with the lower refractive index and the higher degree of wavelength dispersion and a material with the higher refractive index and the lower degree of wavelength dispersion, respectively. In that case, the base 15 may be made of polycarbonate (with a d-line refractive index of 1.585 and an Abbe number of 27.9). On the other hand, the protective coating 14 may be made of an acrylic UV curable resin in which particles of zirconium oxide with a particle size of 10 nm or less are dispersed (with a d-line refractive index of 1.623 and an Abbe number of 40).

In this preferred embodiment, the diffraction steps of the diffraction grating portions 21 of the second group are lower in height than their counterparts of the diffraction grating portions 20 of the first group. Since the diffraction grating portions 20 of the first group are covered with the protective coating 14, their diffraction steps are represented by Equation (2), of which the denominator of the right side is obtained by subtracting the refractive index of the base 15 from that of the protective coating 14. On the other hand, the diffraction steps of the diffraction grating portions 21 of the second group, which are arranged on the surface of the protective coating 14, are represented by Equation (1), of which the denominator of the right side is obtained by subtracting the air refractive index of one from 1.623 that is the refractive index of the protective coating 14. The base 15 has a refractive index that is greater than one. For that reason, the denominator of the right side of Equation (2) becomes smaller than that of Equation (1). Consequently, the height d′ of the diffraction steps calculated by Equation (2) is larger than the height d of the diffraction steps calculated by Equation (1).

Specifically, the diffraction grating portions 20 of the first group, which are covered with the protective coating 14, may have a diffraction step height of 14.9 μm, and Equation (2) is satisfied in that case. On the other hand, the diffraction grating portions 21a of the second group may have a diffraction step height of 0.86 μm. If the wavelength is 550 nm, the diffraction step height that makes the diffraction efficiency 100% is 0.88 μm according to Equation (1). In this case, however, the diffraction step height is set to be slightly smaller than 0.88 μm with the diffraction efficiency over the entire visible radiation range taken into consideration. The base 15 has an aspheric curved shape, which has been determined during the design process of the lens, on the second surface 13. And the first group of diffraction grating portions 20 is located on a first aspheric shape 13a, which is defined by extending that curved shape. That is to say, on the second surface 13 of the base 15, the first group of diffraction grating portions 20 and a smooth surface portion are arranged along the first aspheric shape 13a. Also, on the second surface 13, the first group of diffraction grating portions 20 and the smooth surface portion are arranged in this order outward from the optical axis 10 as shown in FIG. 1. In this case, the “smooth surface” refers to a surface with no diffraction grating portions. And the same statement applies to the rest of this description as far as the “smooth surface” is concerned.

The protective coating 14 also has an aspheric curved shape, which has been determined during the design process of the lens, on the third surface 16. And the second group of diffraction grating portions 21 is located on a second aspheric shape 16a, which is defined by extending that curved shape. That is to say, on the third surface 16 of the protective coating 14, the second group of diffraction grating portions 21 and a smooth surface portion are arranged along the second aspheric shape 16a. Also, on the third surface 16, the smooth surface portion and the second group of diffraction grating portions 21 are arranged in this order outward from the optical axis 10 as shown in FIG. 1.

The aspheric curved shape that the protective coating 14 defines on the third surface 16 (i.e., the first aspheric shape 13a) and the aspheric curved shape that the base 15 defines on the second surface 13 (i.e., the second aspheric shape 16a) may be substantially the same. That is to say, the protective coating 14 may have a substantially uniform thickness as measured parallel to the optical axis 10.

It is preferred that the diffraction grating portions 20 and 21 be arranged in irregular pitches and that the farther away from the optical axis 10, the narrower the pitches. To increase understandability, the number, pitches, and relative sizes of the diffraction grating portions 20 and other lens shapes that are illustrated on the drawings are not exact ones.

The first-order diffraction efficiency with respect to a light ray that has been incident perpendicularly onto the diffraction grating portions 20 of the first group has the wavelength dependence shown in FIG. 2. As can be seen from FIG. 2, the first-order diffraction efficiency is 95% or more over the entire visible radiation range of 400 nm through 700 nm.

The protective coating 14 is preferably formed by performing a molding process using a die. In that case, the inner surface of the die should define the inversion of the third surface 16 of the protective coating shown in FIG. 1. Actually, however, the shape of the die may be slightly larger than the formed product with the rate of shrinkage of the protective coating 14 being cured taken into consideration. If such a die molding process is adopted, the protective coating 14 can be formed relatively easily with high accuracy and in a short time.

Also, the first group of diffraction grating portions 20 arranged in a concentric ring pattern on the surface of the base 15 and the second group of diffraction grating portions 21 arranged in a concentric ring pattern on the surface of the protective coating 14 preferably have the respective centers of their concentric rings substantially aligned with each other. That is to say, as viewed from over the imaging side, the first and second groups of diffraction grating portions 20 and 21 preferably form concentric circles. If the offset between the respective centers of those two concentric rings were 20 μm or more, the image capturing performance of the lens would be affected seriously. However, if such a protective coating 14 having the second group of diffraction grating portions 21 on its surface is formed with a die, it is relatively easy to reduce the offset between their centers with respect to the first group of diffraction grating portions 20 to 10 μm or less.

The surface shape of an aspheric lens can be represented by the following Equation (3):

$$z = \frac{{ch}^{2}}{1 + \sqrt{1 - ( K + 1 ) {c}^{2} {h}^{2}}} + A {h}^{4} + {Bh}^{6} + {Ch}^{8} + {Dh}^{10} + {Eh}^{12} \\ ( {h}^{2} = {x}^{2} + {y}^{2} ) \qquad ( 3 )$$

This Equation (3) represents a cross-sectional shape on an x-y plane that intersects with the optical axis at right angles. The actual lens surface is obtained by rotating what is represented by Equation (3) on a z-axis (i.e., the optical axis) that intersects with the x-y plane at right angles. In Equation (3), c is a coefficient representing a central radius of curvature, and A, B, C, D and E are coefficients representing the degrees of deviation from a second-order curved surface. It should be enough to use these coefficients A through E. But coefficients of a higher order could be used or coefficients of a lower order could also be used. Also, according to the K value, the aspheric surface becomes one of the following surfaces:
if 0>K, an ellipsoid, of which the shorter diameter is the optical axis,
if K=0, a sphere,
if −1<K<0, an ellipsoid, of which the longer diameter is the optical axis,
if K=−1, a paraboloid, and
if K<−1, a hyperboloid

Also, the diffractive surface of the diffractive imaging lens 11 is designed by phase function method. According to a phase function method, a diffraction grating is supposed to be present on a lens surface and the wavefront is subjected, on that surface, to a phase transformation represented by the following Equations (4):

$$φ ( h ) = \frac{2 π}{λ} ψ ( h ) \\ ψ ( h ) = {a}_{2} {h}^{2} + {a}_{4} {h}^{4} + {a}_{6} {h}^{6} + {a}_{8} {h}^{8} + {a}_{10} {h}^{10} \\ ( {h}^{2} = {x}^{2} + {y}^{2} ) \qquad ( 4 )$$

The lens shape is eventually determined to be the sum of the aspheric shape and the group of diffraction grating portions as described above. In Equations (4), φ is a phase function, φ is an optical path function, h is a radial distance, and a₂, a₄, a₆, a₈ and a₁₀ are coefficients. It should be enough to use these coefficients a₂ through a₁₀. But coefficients of a higher order could be used or coefficients of a lower order could also be used. In any case, the order of diffraction is first-order in this example. The design wavelength λ may be the center value of the operating wavelength of the lens, for example.

In the diffractive lens of this preferred embodiment, the aspheric shape is determined by the second surface 13 that is located on the imaging side of the base 15 as shown in FIG. 1. All of those diffraction grating portions should be arranged on either the same plane that crosses the optical axis at right angles or the same aspheric surface that is defined with respect to the optical axis as its axis of rotation by using the phase polynomial of Equation (4). According to the present invention, however, the first and second groups of diffraction grating portions are arranged on two different aspheric surfaces. That is to say, the first and second groups of diffraction grating portions shift from each other by the thickness of the protective coating 14 (e.g., approximately 30 μm in this example) in the optical axis direction. However, this shift will hardly affect the image capturing performance, and therefore, need not be taken into consideration.

In the actual manufacturing process, the SAG of a diffraction grating is determined by the difference in refractive index between the materials and the design wavelength using a phase function and a diffraction grating is formed on a surface with an aspheric shape. For example, when a phase function is used to transform diffraction grating portions, diffraction steps are sometimes provided on a 2mπ basis, where m is the order of diffraction. The shape of the diffraction grating portions is transformed with the sign of the phase function of Equations (4) changed depending on whether or not the refractive index of the base 15 or the protective coating 14 is greater than that of the medium in contact with the diffraction grating portions. The first group of diffraction grating portions 20 on the surface of the base 15 and the second group of diffraction grating portions 21 on the surface of the protective coating 14 may be formed by using the same phase function.

In this preferred embodiment, the diffraction grating portions 20 of the first group are in contact with the protective coating 14 and the base 15 has a lower refractive index than the protective coating 14. That is why the shape of the diffraction grating portions 20 of the base 15 is transformed after the phase function represented by Equations (4) is multiplied by 1. On the other hand, the diffraction grating portions 21 of the second group are in contact with the air layer, and protective coating 14 has a higher refractive index than the air layer. Thus, the shape of the diffraction grating portions 21 of the protective coating 14 is transformed after the phase function represented by Equations (4) is multiplied by −1. Consequently, in the diffractive imaging lens 11 of this preferred embodiment shown in FIG. 1, the condensing power has a positive diffractive surface. In each of the diffraction grating portions 20 of the first group, the first surface 20a, which defines a diffraction step surface, is located closer to the outer periphery of the lens than the second surface 20b thereof is. On the other hand, in each of the diffraction grating portions 21 of the second group, the first surface 21a, which defines a diffraction step surface, is located closer to the optical axis 10 of the lens than the second surface 21b thereof is. If diffracted light, of which the order of diffraction is first-order, needs to be imaged, both of these first surfaces 20a and 21a (which are diffraction step surfaces) are provided on a 2π basis. The phase function is a phase distribution of the wavefront in the optical axis direction with respect to the distance r from the optical axis. And each of the first surfaces 20a and 21a (which are diffraction step surfaces) defined by the phase function becomes parallel to the optical axis. As shown in FIG. 1, in the blazed diffraction grating portions, the respective first surfaces 20a and 21a (which are diffraction step surfaces) are defined on the surfaces of the aspheric shapes 13a and 16a. And with those aspheric shapes 13a and 16a taken into account, the diffractive imaging lens is designed so that the first surfaces 20a and 21a are parallel to the optical axis.

In this preferred embodiment, the protective coating 14 may have a higher refractive index than the base 15. In that case, the shapes of the respective diffraction grating portions 20 and 21 of the base 15 and the protective coating 14 are transformed after the phase function represented by Equation (4) has been multiplied by −1. As a result, in each of the diffraction grating portions 20 of the first group, the first surface 20a (i.e., the diffraction step surface) is located closer to the optical axis 10 of the lens than the second surface 20b is. And in each of the diffraction grating portions 21 of the second group, the first surface 21a (i.e., the diffraction step surface) is located closer to the optical axis 10 of the lens than the second surface 21b is.

The diffractive imaging lens of this preferred embodiment may have the following aspheric coefficients for the first surface 12 that is located closer to the subject and the following aspheric coefficients and phase coefficients for the second and third surfaces 13 and 16 that are located closer to the image sensor. In this preferred embodiment, the aspheric shape 13a of the second surface 13 is supposed to be the same as the aspheric shape 16a of the third surface 16. That is to say, the protective coating 14 has a substantially uniform thickness as measured parallel to the optical axis 10. It should be noted that m is the order of diffraction.

Aspheric Coefficients for First Surface:

K=−0.796834

A=−0.00670146,

B=0.0380988,

C=−0.0364111,

D=0.0132840, and

E=5.82320e−016

Aspheric Coefficients for Second and Third Surfaces:

K=3.749992,

A=0.0670042,

B=−0.0758092,

C=0.0621387,

D=−0.0152972, and

E=5.824155e−016

Phase Coefficients for Second and Third Surfaces:

m=1,

design wavelength λ=538 nm,

a2=−0.0256517,

a4=−0.0252208,

a6=−0.0497239,

a8=−0.0376587, and

10=0.00965820

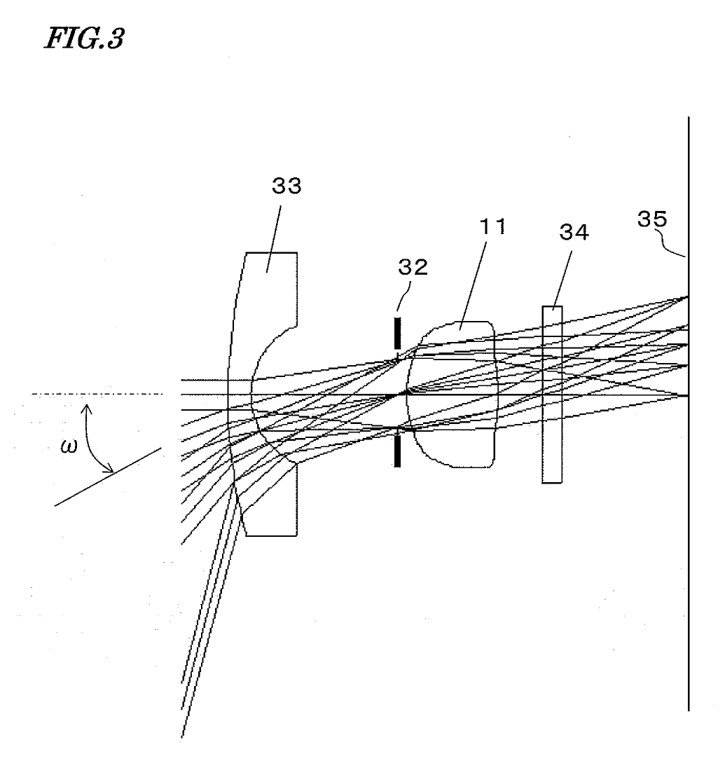

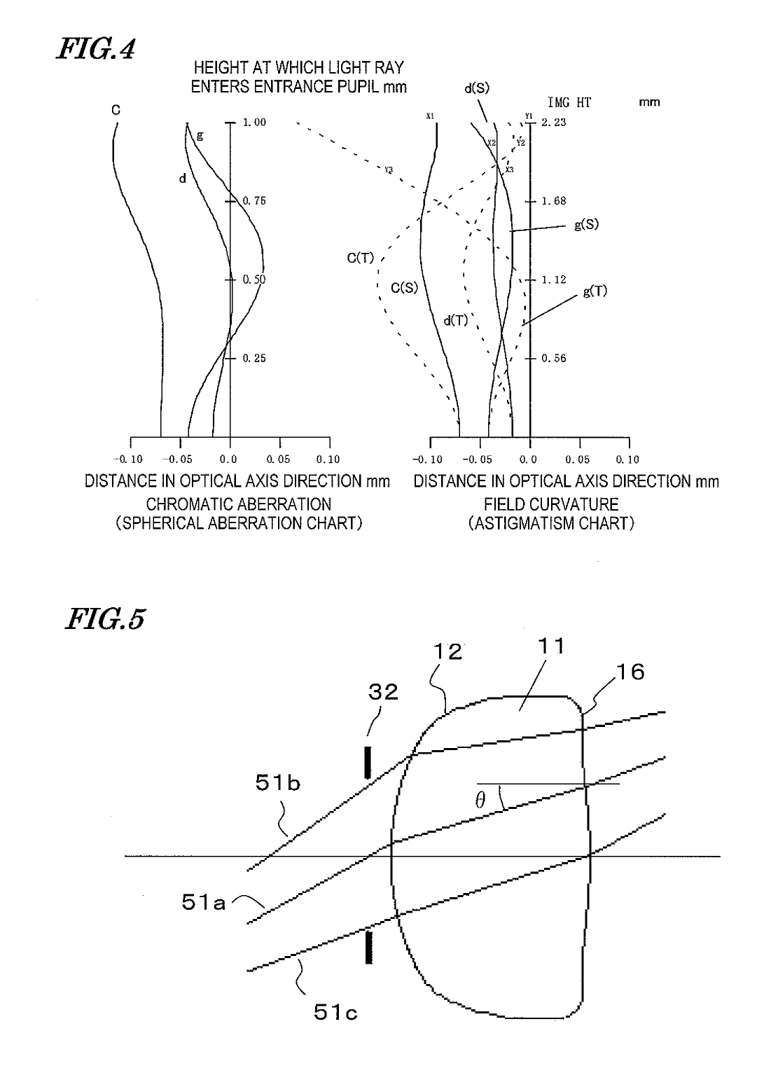

FIG. 3 illustrates an image capture device that uses the diffractive imaging lens 11 of the preferred embodiment shown in FIG. 1.

The image capture device of this preferred embodiment includes the diffractive imaging lens 11 and an imaging optical system, which is arranged closer to the subject than the diffractive imaging lens 11 is and which consists of two lenses including a convex lens 33 made of a glass material. A diaphragm 32 is further arranged closer to the subject than the diffractive imaging lens 11 is to receive the light that has come from the convex lens 33. In FIG. 3, the diffraction grating portions of the diffractive imaging lens 11 are not illustrated. On the other side of the diffractive imaging lens 11 opposite from the diaphragm 32 (or the subject), arranged are a cover glass plate 34 and a solid-state image sensor 35.

The following is some numerical data of the two-lens imaging optical system of this preferred embodiment:

Ω=150°,

Fno=2.8,

L=10.4 mm,

f=1.9004 mm and

h=2.25 mm

where Ω is the full angle of view, Fno is the F number, L is the optical length (i.e., the distance from the top of the subject side of a concave lens to the imaging plane), f is the focal length, h is the maximum image height, R is the radius of curvature [mm] of the surface, t is the surface-to-surface interval [mm] (i.e., the distance between the respective centers of the planes on the optical axis), nd is the d-line refractive index of the base, and ν d is the d-line Abbe number of the base. Surface #1, #2, #3, #4, #5, #6 and #7 represent the subject side of a concave lens, the imaging side of the concave lens, the diaphragm, the subject side of the diffractive imaging lens, the imaging side of the diffractive imaging lens, the subject side of the cover glass plate 34, and the imaging side of the cover glass plate 34, respectively. In the diffractive imaging lens 11 of this preferred embodiment, the first and second surfaces 12 and 16 correspond to Surfaces #4 and #5, respectively.

TABLE 1

| Surface # | R | t | nd | νd |
|---|---|---|---|---|
| 1 | 12.35704 | 0.519999 | 1.77250 | 49.62 |
| 2 | 1.686732 | 3.29229 | | |
| 3 (diaphragm) | Infinity | 0.241345 | | |
| 4 | 2.655821 | 2.047438 | 1.585000 | 27.9 |
| 5 | −4.63202 | 1.010682 | | |
| 6 | Infinity | 0.440999 | BK7 | |
| 7 | Infinity | 2.845853 | | |

The effective focal length f was measured at a wavelength of 550 nm.

In the image capture device of this preferred embodiment, the light that has come from the subject enters the concave lens 33, which refracts the incoming light with its high refraction ability so that the light that has struck the lens 33 with a high angle of view and a large angle of incidence has its steep angle with respect to the optical axis decreased. This concave lens 33 contributes to reducing the aberration of the overall lens system. Next, the light that has been refracted by the concave lens 33 is incident on the diffractive imaging lens 11 by way of the diaphragm 32. In this preferred embodiment, since the light that has come from the subject is incident on both of the first and second groups of diffraction grating portions 20 and 21, the light rays that have been incident on the first and second groups of diffraction grating portions 20 and 21 fall within the same wavelength range. Thereafter, the light leaves the diffractive imaging lens 11, is transmitted through the cover glass plate 34, and then is observed as an image on the solid-state image sensor 35. Subsequently, as shown in FIG. 3, the solid-state image sensor 35 receives the light rays that have been transmitted through those first and second groups of diffraction grating portions 20 and 21 of the diffractive imaging lens 11 on the same imaging plane and then converts the light rays into an electrical signal. After that, the electrical signal thus generated by the solid-state image sensor 35 is transformed into an image by a computing circuit (not shown) that produces a subject image.

To reduce the aberration produced by the lens, it is preferred that the light ray be incident on the lens surface with a smaller angle of incidence and a smaller angle of refraction. By adding a diffraction grating with positive power to the diffractive imaging lens 11, the chromatic aberration of the lens that has been produced by the refraction system can be compensated for.

The concave lens 33 is preferably a so-called “meniscus concave lens” with a convex subject side. This is because a meniscus concave lens 33 would reduce the angle of incidence of the incoming light that is going to strike the concave lens 33 with a wide angle of view and therefore should cut down the reflection loss at the surface. And to reduce the angle of incidence of the incoming light that has come with a wide angle of view, it is preferred that the concave lens 33 have high refraction ability (i.e., a high refractive index).

FIG. 4 shows the chromatic aberration and the magnitude of field curvature of the two-lens imaging optical system of the image capture device shown in FIG. 3 as a spherical aberration chart and an astigmatism chart, respectively. In the spherical aberration chart, the abscissa represents the distance in the optical axis direction and the ordinate represents the height at which the light ray enters the entrance pupil, which plots the point of intersection between the light ray and the optical axis. In this chart, C represents a C-line (with a wavelength of 656.27 nm), d represents a d-line (with a wavelength of 587.56 nm) and g represents a g-line (with a wavelength of 435.83 nm). And the difference between their imaging points is the magnitude of axial chromatic aberration.

On the other hand, in the astigmatism chart, the abscissa represents the distance in the optical axis direction and the ordinate represents the image height. Therefore, the distance represented by the abscissa means the magnitude of field curvature at each image height. In this astigmatism chart, T and S represent a tangential and a sagital, which are indicated by the dotted curve and the solid curve, respectively.

As can be seen from the astigmatism chart shown in FIG. 4, the chromatic aberration could be compensated for even at a wide angle of view. To establish an optical system, of which the performance is comparable to the counterpart of this preferred embodiment, without using a diffractive imaging lens, at least three aspheric lenses should be used. That is why by introducing the diffractive imaging lens, the number of lenses to use can be reduced and the overall performance can be improved, too.

Next, the diffraction steps and the diffraction efficiency of the diffractive imaging lens 11 of this preferred embodiment will be described in detail. The total number of concentric diffraction steps on the second and third surfaces 13 and 16 of this diffractive imaging lens 11 is 91.

FIG. 5 illustrates a light ray that is passing through the diaphragm 32 and the diffractive imaging lens 11 in the image capture device shown in FIG. 3. In FIG. 5, the diffraction grating portions on the third surface 16 of the diffractive imaging lens 11 are not illustrated.

This optical system has an angle of view of 150 degrees. That is why the concave lens 33 shown in FIG. 3 receives light rays that define angles of −75 degree through 75 degree (i.e., a half angle of view ω) with respect to the optical axis and gets them imaged on the image sensor 35. In FIG. 5, paying attention to the light that is passing through the diaphragm 32, it can be seen that even the light rays that have been incident there with the same angle of view will define varying angles with respect to the optical axis depending on exactly where the light rays pass through the diaphragm 32. The light illustrated in FIG. 5 is incident on the concave lens at a half angle of view of 75 degrees. However, the light ray (i.e., the chief ray) 51a passing through the center of the diaphragm 32, the light ray 51b passing through the upper end of the diaphragm on the paper, and the light ray 51c passing through the lower end of the diaphragm on the paper define mutually different angles (of 28.9, 35.1 and 19.9 degrees, respectively) with respect to the optical axis 10 when passing through the diaphragm 32. Likewise, those light rays will define mutually different angles of incidence with respect to the first and third surfaces 12 and 16 of the diffractive imaging lens 11, too.

Next, the second and third surfaces 13 and 16 of the diffractive imaging lens 11 will be described. As shown in FIG. 1, the first group of diffraction grating portions 20 is arranged in a concentric ring pattern on the second surface 13 that the base 15 has on the imaging side, while the second group of diffraction grating portions 21 is arranged in a concentric ring pattern on the third surface 16 that the protective coating 14 has on the imaging side. The second group of diffraction grating portions 21 is located farther away from the optical axis 10 than the first group of diffraction grating portions 20 is.

On the second and third surfaces 13 and 16 of the diffractive imaging lens 11, there are 91 diffraction steps (i.e., the respective first surfaces 20a and 21a of the diffractive imaging lens 11), which are arranged concentrically around the optical axis 10. These diffraction steps are numbered sequentially from the one that is located closest to the optical axis 10, and those numbers will be referred to herein as “diffraction step numbers”. The following Tables 2-1 and 2-2 show the distance (mm) of each of those diffraction steps from the optical axis 10, its diffraction step pitch (μm), which is the interval between that diffraction step and the previous one, of which the diffraction step number is smaller by one than the former's, the smallest angle θmin defined with respect to the optical axis by one of the light rays that has been incident on the optical system with a half angle of view ω of −75 degrees through 75 degrees and that passes through that diffraction step, the half angle of view ωmin of that light ray, the largest angle θmax defined by another one of those incoming light rays with respect to the optical axis, and the half angle of view ωmax of that light ray. θ and ω are shown in FIGS. 5 and 3, respectively.

TABLE 2-1

| | | | | HALF ANGLE | | HALF ANGLE | AVERAGE |
|---|---|---|---|---|---|---|---|
| | | | SMALLEST | OF VIEW | LARGEST | OF VIEW | ANGLE OF |
| DIFFRACTION | DISTANCE | DIFFRACTION | ANGLE OF | ωmin (deg) | ANGLE OF | ωmax (deg) | INCIDENCE |
| STEP | (mm) FROM | STEP PITCH | INCIDENCE | FOR THAT | INCIDENCE | FOR THAT | θave (deg) |
| NUMBER | OPTICAL AXIS | (μm) | θmin (deg) | ANGLE | θmax (deg) | ANGLE | DEFINED |
| 1 | 0.1435 | 143.5 | −14 | −55 | 17 | 75 | 0 |
| 2 | 0.2012 | 57.7 | −13 | −50 | 17 | 75 | −0.5 |
| 3 | 0.2446 | 43.4 | −12 | −48 | 17 | 75 | −0.4 |
| 4 | 0.2806 | 36 | −12 | −45 | 17 | 75 | −0.8 |
| 5 | 0.3119 | 31.3 | −12 | −42 | 17 | 75 | −1.1 |
| 6 | 0.3398 | 27.9 | −11 | −39 | 17 | 75 | −1.2 |
| 7 | 0.3654 | 25.6 | −10 | −37 | 17 | 75 | −1.4 |
| 8 | 0.389 | 23.6 | −10 | −35 | 17 | 75 | −1.5 |
| 9 | 0.411 | 22 | −10 | −33 | 17 | 75 | −1.5 |
| 10 | 0.4318 | 20.8 | −9 | −31 | 17 | 75 | −1.5 |
| 11 | 0.4516 | 19.8 | −9 | −29 | 17 | 75 | −1.6 |
| 12 | 0.4704 | 18.8 | −8 | −27 | 17 | 75 | −1.6 |
| 13 | 0.4885 | 18.1 | −8 | −25 | 17 | 75 | −1.6 |
| 14 | 0.5059 | 17.4 | −8 | −24 | 17 | 75 | −1.6 |
| 15 | 0.5227 | 16.8 | −7 | −23 | 17 | 75 | −1.5 |
| 16 | 0.539 | 16.3 | −7 | −21 | 17 | 75 | −1.5 |
| 17 | 0.5548 | 15.8 | −7 | −20 | 17 | 75 | −1.4 |
| 18 | 0.5703 | 15.5 | −6 | −18 | 17 | 75 | −1.3 |
| 19 | 0.5854 | 15.1 | −6 | −17 | 17 | 75 | −1.3 |
| 20 | 0.6001 | 14.7 | −6 | −15 | 17 | 75 | −1.2 |
| 21 | 0.6146 | 14.5 | −6 | −14 | 17 | 75 | −1.1 |
| 22 | 0.6288 | 14.2 | −5 | −13 | 17 | 75 | −1 |
| 23 | 0.6427 | 13.9 | −5 | −12 | 17 | 75 | −1 |
| 24 | 0.6565 | 13.8 | −5 | −10 | 17 | 75 | −0.8 |
| 25 | 0.67 | 13.5 | −4 | −9 | 17 | 75 | −0.6 |
| 26 | 0.6833 | 13.3 | −4 | −8 | 17 | 75 | −0.5 |
| 27 | 0.6965 | 13.2 | −4 | −6 | 17 | 75 | −0.3 |
| 28 | 0.7095 | 13 | −3 | −5 | 17 | 75 | −0.1 |
| 29 | 0.7223 | 12.8 | −3 | −4 | 17 | 75 | 0.1 |
| 30 | 0.735 | 12.7 | −3 | −3 | 17 | 75 | 0.1 |
| 31 | 0.7476 | 12.6 | −3 | −1 | 17 | 75 | 0.2 |
| 32 | 0.76 | 12.4 | −2 | 1 | 16 | 75 | 0.5 |
| 33 | 0.7722 | 12.2 | −2 | 3 | 16 | 75 | 0.7 |
| 34 | 0.7844 | 12.2 | −2 | 3 | 16 | 75 | 0.8 |
| 35 | 0.7964 | 12 | −2 | 4 | 16 | 75 | 0.9 |
| 36 | 0.8083 | 11.9 | −1 | 5 | 16 | 75 | 1 |
| 37 | 0.8201 | 11.8 | −1 | 6 | 16 | 75 | 1.1 |
| 38 | 0.8317 | 11.6 | −1 | 8 | 16 | 75 | 1.3 |
| 39 | 0.8432 | 11.5 | −1 | 9 | 16 | 75 | 1.5 |
| 40 | 0.8546 | 11.4 | 0 | 10 | 15 | 75 | 1.6 |
| 41 | 0.8658 | 11.2 | 0 | 11 | 15 | 75 | 1.9 |
| 42 | 0.8769 | 11.1 | 0 | 12 | 15 | 75 | 1.9 |
| 43 | 0.8878 | 10.9 | 0 | 14 | 15 | 75 | 2.1 |
| 44 | 0.8986 | 10.8 | 1 | 14 | 15 | 75 | 2.3 |
| 45 | 0.9093 | 10.7 | 1 | 16 | 15 | 75 | 2.5 |
| 46 | 0.9198 | 10.5 | 1 | 17 | 15 | 75 | 2.7 |
| 47 | 0.9302 | 10.4 | 1 | 18 | 15 | 75 | 2.9 |
| 48 | 0.9404 | 10.2 | 2 | 19 | 14 | 75 | 2.9 |
| 49 | 0.9504 | 10 | 2 | 21 | 14 | 75 | 3.3 |
| 50 | 0.9603 | 9.9 | 2 | 22 | 14 | 75 | 3.3 |
| 51 | 0.9701 | 9.8 | 2 | 23 | 14 | 75 | 3.5 |
| 52 | 0.9797 | 9.6 | 2 | 23 | 14 | 75 | 3.5 |

TABLE 2-2

| | | | | HALF ANGLE | | HALF ANGLE | AVERAGE |
|---|---|---|---|---|---|---|---|
| | | | SMALLEST | OF VIEW | LARGEST | OF VIEW | ANGLE OF |
| DIFFRACTION | DISTANCE | DIFFRACTION | ANGLE OF | ωmin (deg) | ANGLE OF | ωmax (deg) | INCIDENCE |
| STEP | (mm) FROM | STEP PITCH | INCIDENCE | FOR THAT | INCIDENCE | FOR THAT | θave (deg) |
| NUMBER | OPTICAL AXIS | (μm) | θmin (deg) | ANGLE | θmax (deg) | ANGLE | DEFINED |
| 53 | 0.9891 | 9.4 | 3 | 25 | 14 | 75 | 3.9 |
| 54 | 0.9984 | 9.3 | 3 | 26 | 14 | 75 | 4 |
| 55 | 1.0075 | 9.1 | 3 | 27 | 14 | 75 | 4.1 |
| 56 | 1.0165 | 9 | 3 | 28 | 13 | 75 | 4.3 |
| 57 | 1.0254 | 8.9 | 3 | 29 | 13 | 75 | 4.4 |
| 58 | 1.0341 | 8.7 | 4 | 31 | 13 | 75 | 4.6 |
| 59 | 1.0427 | 8.6 | 4 | 32 | 13 | 75 | 4.8 |
| 60 | 1.0512 | 8.5 | 4 | 33 | 13 | 75 | 4.9 |
| 61 | 1.0595 | 8.3 | 4 | 34 | 13 | 75 | 5 |
| 62 | 1.0677 | 8.2 | 4 | 35 | 13 | 75 | 5.2 |
| 63 | 1.0758 | 8.1 | 5 | 36 | 13 | 75 | 5.3 |
| 64 | 1.0838 | 8 | 5 | 37 | 12 | 75 | 5.5 |
| 65 | 1.0917 | 7.9 | 5 | 38 | 12 | 75 | 5.6 |
| 66 | 1.0995 | 7.8 | 5 | 39 | 12 | 75 | 5.7 |
| 67 | 1.1072 | 7.7 | 5 | 41 | 12 | 75 | 6 |
| 68 | 1.1148 | 7.6 | 5 | 42 | 12 | 75 | 6.1 |
| 69 | 1.1223 | 7.5 | 6 | 43 | 12 | 75 | 6.2 |
| 70 | 1.1297 | 7.4 | 6 | 43 | 12 | 75 | 6.3 |
| 71 | 1.1371 | 7.4 | 6 | 44 | 12 | 75 | 6.3 |
| 72 | 1.1445 | 7.4 | 6 | 46 | 11 | 75 | 6.6 |
| 73 | 1.1518 | 7.3 | 6 | 47 | 11 | 75 | 6.7 |
| 74 | 1.159 | 7.2 | 6 | 48 | 11 | 75 | 6.8 |
| 75 | 1.1662 | 7.2 | 6 | 48 | 11 | 75 | 6.9 |
| 76 | 1.1734 | 7.2 | 7 | 51 | 11 | 75 | 7.2 |
| 77 | 1.1806 | 7.2 | 7 | 52 | 11 | 75 | 7.3 |
| 78 | 1.1877 | 7.1 | 7 | 52 | 11 | 75 | 7.3 |
| 79 | 1.1949 | 7.2 | 7 | 54 | 11 | 75 | 7.5 |
| 80 | 1.2021 | 7.2 | 7 | 56 | 10 | 75 | 7.7 |
| 81 | 1.2093 | 7.2 | 7 | 57 | 10 | 75 | 7.8 |
| 82 | 1.2166 | 7.3 | 8 | 58 | 10 | 75 | 7.9 |
| 83 | 1.224 | 7.4 | 8 | 59 | 10 | 75 | 7.9 |
| 84 | 1.2315 | 7.5 | 8 | 62 | 10 | 75 | 8.3 |
| 85 | 1.2391 | 7.6 | 8 | 63 | 10 | 75 | 8.3 |
| 86 | 1.2468 | 7.7 | 8 | 64 | 10 | 75 | 8.3 |
| 87 | 1.2548 | 8 | 8 | 67 | 10 | 75 | 8.7 |
| 88 | 1.2631 | 8.3 | 9 | 68 | 9 | 75 | 8.7 |
| 89 | 1.2717 | 8.6 | 9 | 71 | 9 | 75 | 9 |
| 90 | 1.2808 | 9.1 | 9 | 73 | 9 | 75 | 9 |
| 91 | 1.2907 | 9.9 | 9 | 75 | 9 | 75 | 9 |

For example, diffraction step #10 is located at a distance (i.e., has a diffraction ring radius) of 0.4318 mm from the optical axis 10 and at an interval (i.e., has a diffraction step pitch) of 20.8 μm from the previous diffraction step #9. The light ray striking this diffraction step has an angle of incidence θ of −9 to 17 degrees. The half angle of view ω for a θmin of −9 degrees is −31 degrees. And the half angle of view ω for a θmax of 17 degrees is 75 degrees.

As can be seen, light rays with mutually different angles of incidence pass through the same diffraction step. In this description, the average angle of incidence θave is defined by the following Equation (5):

θave=(θₘᵢₙ×cos⁴ωₘᵢₙ+θₘₐₓ×cos⁴ωₘₐₓ+(θₘᵢₙ+θₘₐₓ)/2×(cos⁴(ωₘᵢₙ+θₘₐₓ)/2))/(cos⁴ωₘᵢₙ+cos⁴ωₘₐₓ+cos⁴(ωₘᵢₙ+θₘₐₓ)/2) (5)

Suppose there is a planar subject that intersects with the optical axis 10 at right angles and that has uniform brightness. In that case, the luminous flux of the light striking the entrance pupil of the lens is proportional to the fourth power of cos ω with respect to the half angle of view ω. That is to say, the greater the absolute value of the half angle of view ω of a light ray, the smaller the quantity of the light entering the lens. In view of this consideration, according to Equation (5), the average angle of incidence θave is defined by adding a weight of the fourth power of cos ω to the three half angles of view ωmin, ωmax and their average (ωmin+ωmax)/2.

This is based on the supposition that even if light rays actually strike the diffraction grating portions at multiple different angles of incidence, a diffractive imaging lens that would produce a minimum flare can still be obtained by replacing those rays with light rays that are incident with only their average angle θave and by determining a condition for achieving a high diffraction efficiency for that light ray.

The diffraction step #10 has a θave of −1.5 degrees, which means that the incoming light ray is substantially parallel to the optical axis. In this case, the larger the diffraction step number, the greater the θave value. That is to say, the more distant from the optical axis 10 a diffraction step, the larger the average angle of incidence of light rays on the diffraction step. Also, the more distant from the optical axis 10 a diffraction step, the smaller the pitch of the diffraction step.

To obtain the diffraction efficiency in a situation where light rays are incident on the diffraction grating portions obliquely with respect to the optical axis, the present inventors carries out simulations by RCWA method, which is one of various electromagnetic field analysis methods, using the diffraction pitch as a parameter.

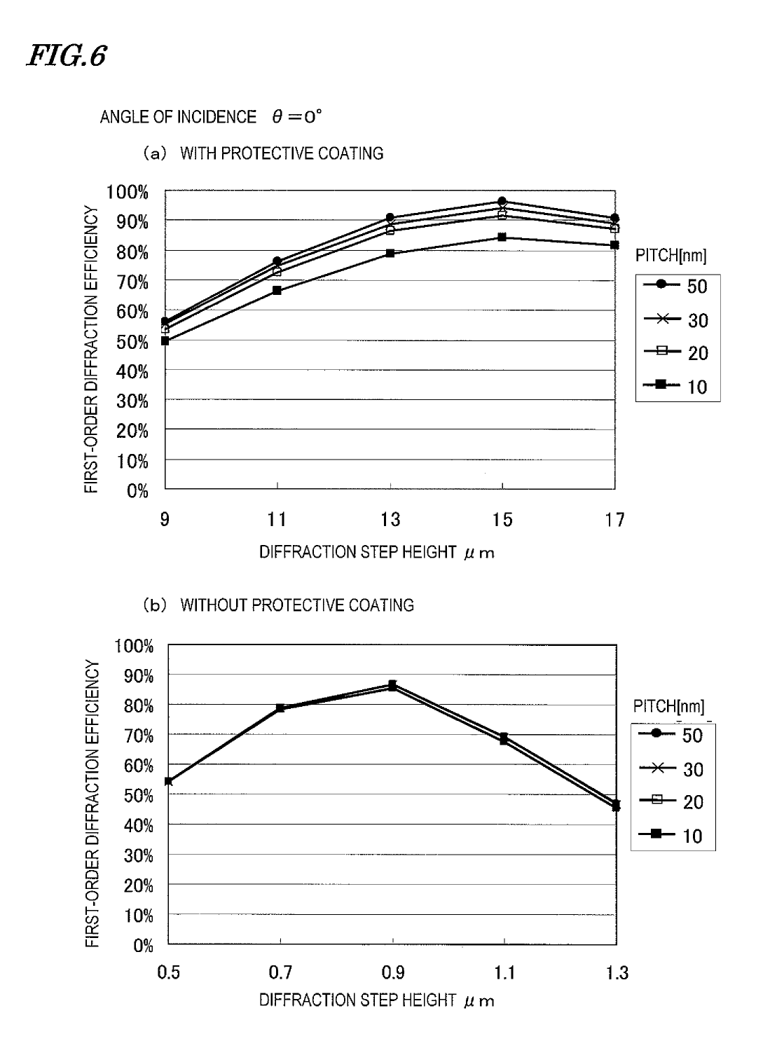

FIG. 6 illustrates two graphs showing the results obtained for a light ray with θ=0 degrees, i.e., a light ray that was incident on the diffraction step parallel to the optical axis. Specifically, FIG. 6(a) shows the results obtained by using an optical system with a protective coating covering the diffraction grating portions, while FIG. 6(a) shows the results obtained by using an optical system without a protective coating covering the diffraction grating portions. The results of simulations shown in FIG. 6(a) were obtained by using diffraction grating portions made of polycarbonate (with a d-line refractive index of 1.585 and an Abbe number of 27.9) and a protective coating 14 made of an acrylic UV curable resin in which particles of zirconium oxide with a particle size of 10 nm or less were dispersed. On the other hand, the results of simulations shown in FIG. 6(b) were obtained by using diffraction grating portions made of the same material as the protective coating 14, i.e., an acrylic UV curable resin in which particles of zirconium oxide with a particle size of 10 nm or less were dispersed.

In FIGS. 6(a) and 6(b), the abscissa represents the height of the diffraction step, the ordinate represents the first-order diffraction efficiency, and results of simulations that were obtained with various diffraction pitches of 10, 20, 30 and 50 μm are shown. In this case, the first-order diffraction efficiency represented by the ordinate was calculated as a weighted average by adding a weight to the wavelength. Generally speaking, when a color image is generated by a solid-state image sensor, the light rays in the respective colors of red, green and blue will contribute to generating the image to mutually different degrees. Specifically, the luminance of a green ray usually contributes more significantly than any other light ray's does. Thus, in this example, the wavelength dependence of the first-order diffraction efficiency shown in FIG. 2 was determined, the diffraction efficiency was weighted to varying degrees according to how much the respective light rays would contribute to generating the image, and then the average first-order diffraction efficiency was calculated. Specific weights added to light rays with respective wavelengths of 656 nm, 589 nm, 546 nm, 480 nm and 405 nm were 1, 4, 7, 5 and 1, respectively.

As shown in FIG. 2, the optical system in which the diffraction grating portions were covered with the protective coating 14 always had as high diffraction efficiency as 90% or more irrespective of the wavelength. It should be noted that that the results shown in FIG. 2 were obtained when the diffraction step height was 14.9 μm. As shown in FIG. 6(a), however, the smaller the pitch, the lower the first-order diffraction efficiency. As for the optical system in which the diffraction grating portions were not covered with the protective coating, on the other hand, it can be seen from FIG. 6(b) that the first-order diffraction efficiency did depend on the diffraction step height but hardly depended on the pitch. And as can be seen from FIG. 6(a), when the diffraction pitch was approximately 10 μm, the optical system in which the diffraction grating portions were covered with the protective coating 14 had a first-order diffraction efficiency of 50% to 85%. And this range is almost no different from that of the first-order diffraction efficiency of the optical system in which the diffraction grating portions were not covered with the protective coating.

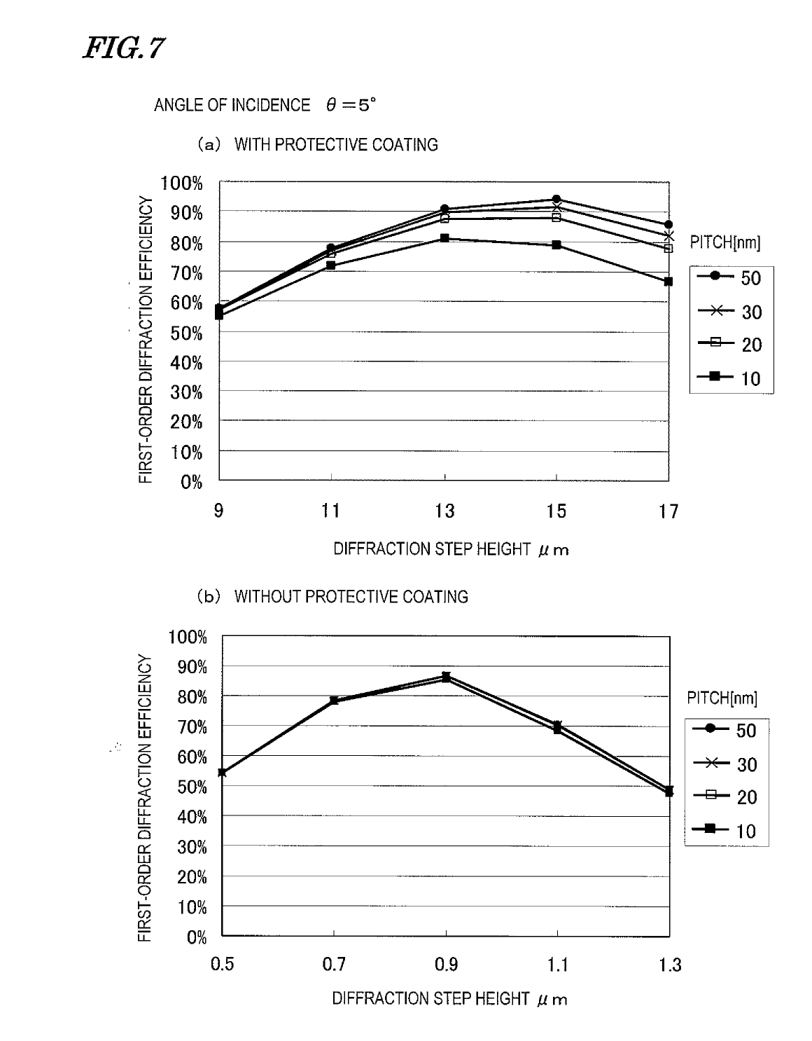

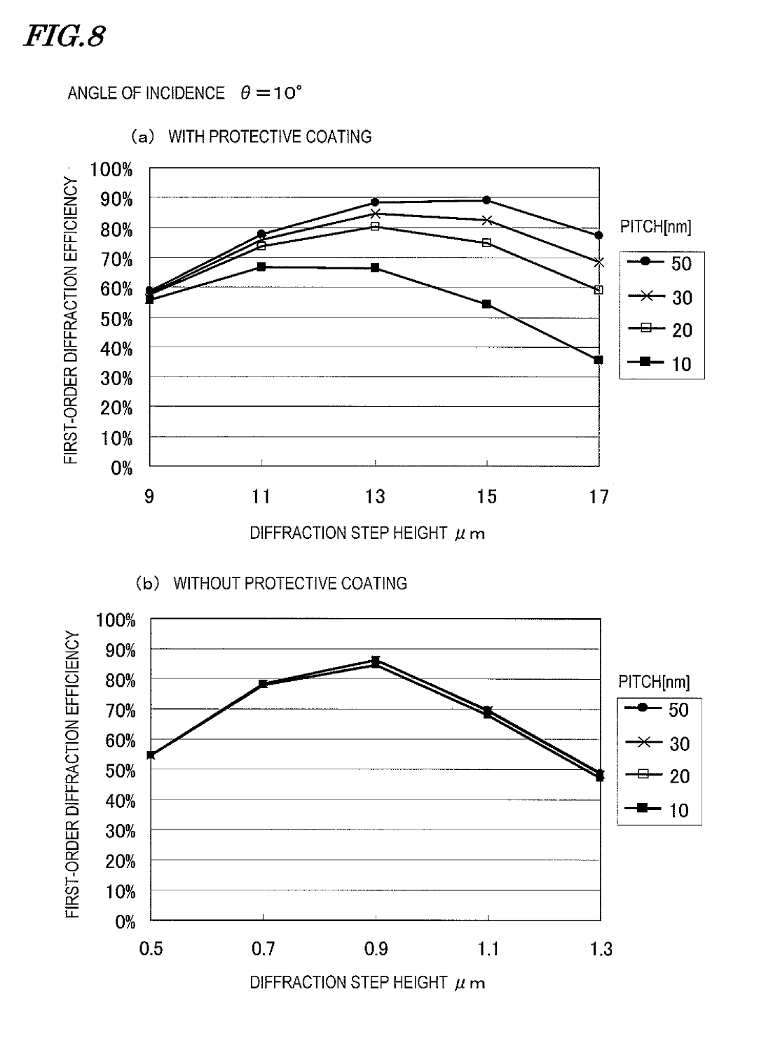

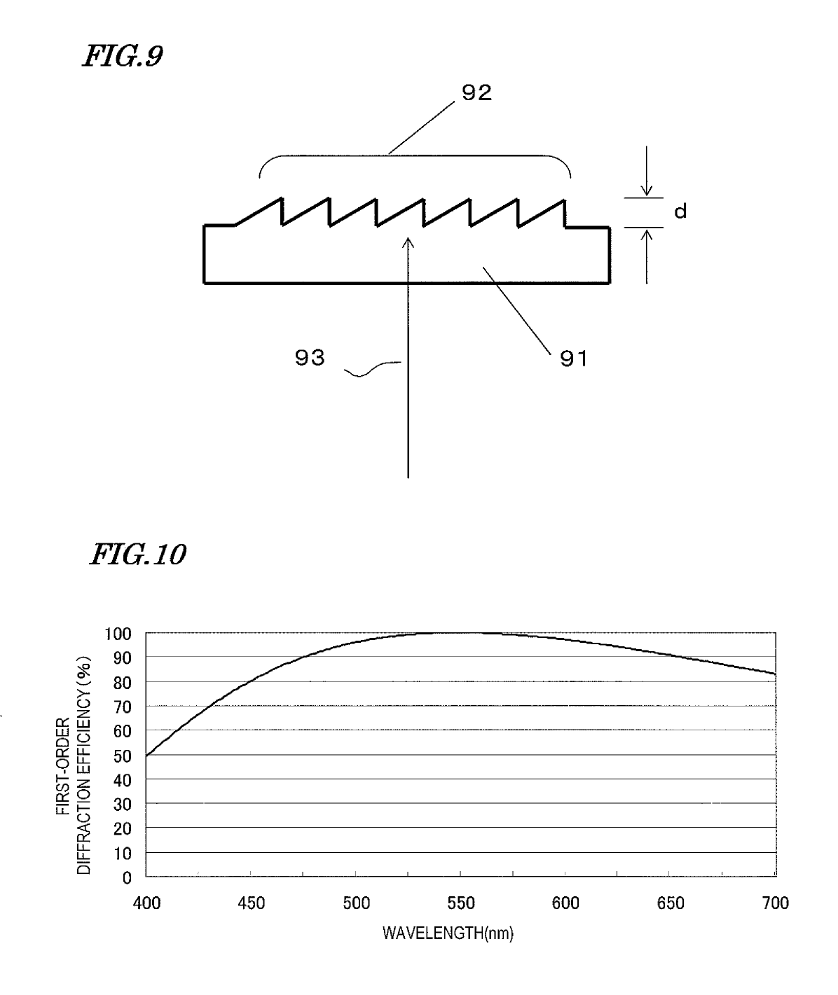

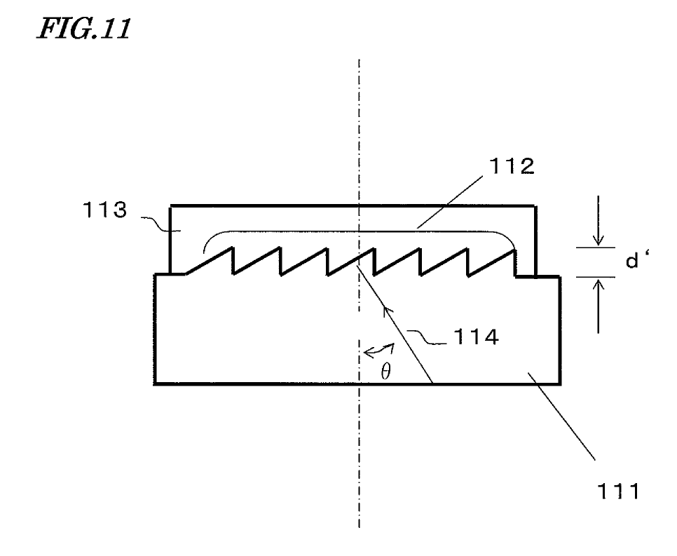

FIGS. 7 and 8 show how the first-order diffraction efficiency varied with the diffraction step height when θ=5 degrees and when θ=10 degrees, respectively. As can be seen from FIGS. 7(b) and 8(b), the first-order diffraction efficiency of the optical system in which the diffraction grating portions were not covered with the protective coating was almost no different from the situation where θ=0 degrees as shown in FIG. 6(b).

On the other hand, the peak value in the graph shown in FIG. 6(a) is higher than the peak at any pitch shown in FIG. 6(b). In the graph shown in FIG. 7(a), the peak value (of approximately 81%) of the curve for a pitch of 10 μm is smaller than the peak value (of approximately 85%) of the curve for the same pitch of 10 μm shown in FIG. 7(b). Likewise, in the graph shown in FIG. 8(a), the peak value (of approximately 67%) of the curve for a pitch of 10 μm is also smaller than the peak value (of approximately 85%) of the curve for the same pitch of 10 μm shown in FIG. 8(b). Furthermore, although the first-order diffraction efficiency represented by the curve for a pitch of 10 μm in the graph shown in FIG. 8(a) decreases to about 36% when the diffraction step height is 17 μm, the lowest first-order diffraction efficiency is approximately 47% in FIG. 8(b). As can be seen, the decrease in first-order diffraction efficiency is not so significant in FIG. 8(b) as in FIG. 8(a). The first-order diffraction efficiency will decrease steeply in this manner if a protective coating is provided for a diffraction grating on which a light ray is incident at a large angle. This is probably because with the protective coating provided, the diffraction step height should be increased so much that a greater quantity of light would cross that step and deviate from the originally designed optical path, and a smaller quantity of light would be diffracted with a desired angle of diffraction.

These results reveal that if θ is zero, the first-order diffraction efficiency will increase by covering the diffraction grating portions with the protective coating, irrespective of the pitch of the diffraction steps but that if θ is equal to or greater than 5 degrees, it depends on the pitch of the diffraction steps whether the diffraction grating portions should be covered with the protective coating or not. According to FIGS. 7 and 8, if the pitch falls within the range of 15μm to 20 μm, the first-order diffraction efficiency would be higher without covering the diffraction grating portions with the protective coating. On the other hand, if the pitch is equal to or greater than 50 μm, then the first-order diffraction efficiency would be higher with the diffraction grating portions covered with the protective coating.

The second group of diffraction grating portions 21 is arranged farther away from the optical axis 10 than the first group of diffraction grating portion 20 is, and therefore, the average angle of incidence of light rays that strike the second group of diffraction grating portions 21 is relatively large. Also, the farther away from the optical axis 10, the smaller the pitches of the first and second groups of diffraction grating portions 20 and 21. And the second group of diffraction grating portions 21 has a pitch of 30 μm or less. That is why the first-order diffraction efficiency would rather increase with the second group of diffraction grating portions 21 arranged on the surface of the protective coating 14 (i.e., not covered with the protective coating).

As shown in Table 1, in the diffractive imaging lens 11 of this preferred embodiment, the average angle of incidence θave is 5 degrees or more from diffraction step #61 on. But the diffraction grating portions with diffraction steps #1 through #30 (i.e., every diffraction step that is located closer to the optical axis than diffraction step #30 is) are arranged on the base 15 and covered with the protective coating 14 in view of the diffraction pitch. On the other hand, the diffraction grating portions with diffraction steps #31 through #91 (i.e., every diffraction step that is located closer to the outer edge than diffraction step #30 is) are arranged on the protective coating 14. Hereinafter, it will be described in detail why this arrangement is preferred. Look at Table 1, and you can see that the diffraction step #61 has a diffraction step pitch of 8.3 μm. In FIG. 7(a) showing the first-order diffraction efficiency in a situation where θ is 5 degrees, the curve for a pitch of 10 μm, which is closer to that pitch of 8.3 μm than any other pitch shown there, has a peak of first-order diffraction efficiency of approximately 80% when the diffraction step height is 13 μm. Since the actual pitch of 8.3 μm is smaller than 10 μm, the peak value should be even lower than 82%. On the other hand, in FIG. 7(b), the curve for a pitch of 10 μm has a peak of first-order diffraction efficiency of approximately 85% when the diffraction step height is 0.9 μm. In the graph shown in FIG. 7(b), the first-order diffraction efficiency has a similar behavior at any pitch, and therefore, the peak value would also be approximately 85% even if the pitch is 8.3 μm. This result reveals that the first-order diffraction efficiency of the diffraction grating portion with the diffraction step #61 should be increased by arranging the diffraction grating portions on the surface of the protective coating 14 rather than arranging the diffraction grating portions on the base 15 and covering them with the protective coating 14. In this manner, the present inventors determined whether the protective coating should or should not be provided for each of those diffraction steps to increase the first-order diffraction efficiency. And based on the results thus collected, no protective coating is provided according to this preferred embodiment for the diffraction grating portions with diffraction steps #31 through #91.

The diffraction steps #1 through #30 have a diffraction step height of 14.9 μm, while the diffraction steps #31 and on have a diffraction step height of 0.9 μm, at which the highest diffraction efficiency is achieved as shown in FIG. 7(b).

Optionally, in this preferred embodiment, the farther away from the optical axis, the lower the diffraction step height of the first group of diffraction grating portions 20 may be. For example, the first group of diffraction grating portions 20 may have a diffraction step height that falls within the range of 13 μm to 14.9 μm and that decreases gradually outward (i.e., as the distance from the optical axis increases). Look at the curves for a pitch of 20 μm shown in FIGS. 6(a), 7(a) and 8(a), for example, and it can be seen that the diffraction step heights associated with the peak of the first-order diffraction efficiency are 15 μm, 13-15 μm and 13 μm, respectively. These results reveal that the larger the angle of incidence of the incoming light, the lower the height of the diffraction step associated with the peak of the first-order diffraction efficiency. The average angle of incidence of the light rays that strike the first group of diffraction grating portions 20 increases as the distance from the optical axis increases. That is why if the heights of the diffraction steps of the first group of diffraction grating portions 20 are decreased as the distance from the optical axis increases, then high first-order diffraction efficiency will be achieved at each of those diffraction grating portions 20 of the first group.

Likewise, the diffraction steps of the second group of diffraction grating portions 21 may also have their height decreased as the distance from the optical axis increases.

In the preferred embodiment described above, the first group of diffraction grating portions 20 is covered with the protective coating 14, while the second group of diffraction grating portions 21 is arranged on the surface of the protective coating 14 and just exposed to the air. Thus, the first-order diffraction efficiency can be increased even in the second group of diffraction grating portions 21 and unwanted diffracted rays other than the first-order ones can be reduced. In this manner, the first-order diffraction efficiency of light rays that strike the lens at relatively large angles of incidence can be increased. That is why even if this diffractive imaging lens 11 is used as a wide-angle lens, a flare that would otherwise be caused due to the presence of those unwanted diffracted rays can be minimized and the decrease in the contrast of the image can be avoided. What's more, since the light that enters the lens at a large angle of incidence will be lost only a little, the peripheral portion of the image can be bright enough.

The image capture device of the preferred embodiment shown in FIG. 3 can produce a color image, of which the resolution is high in a rather broad range, using only two lenses. Thus, the image capture device of this preferred embodiment can reduce the minimum required number of lenses to use compared to conventional ones, and therefore, can have a smaller size and thickness than its counterparts. In addition, the process of positioning and aligning the respective lenses can be simplified, thus achieving higher productivity while cutting down the costs. Consequently, the image capture device of the present invention can be used particularly effectively as a car camera, a surveillance camera, a medical device camera, a cellphone camera or a digital camera, to name just a few.

It should be noted that the diffractive imaging lens of the present invention does not have to use the particular lens shape or lens material of the diffractive imaging lens 11 of the preferred embodiment described above.

In the preferred embodiment described above, the base 15 is supposed to be made of polycarbonate and the protective coating 14 is supposed to be made of an acrylic UV curable resin in which particles of zirconium oxide are dispersed. However, the base 15 and the protective coating 14 do not always have to be made of these materials but may also be made of glass materials, for example. Nevertheless, considering productivity and cost benefits, it is still preferred that both the lens base 15 and the protective coating 14 be made of resin-based materials. Among other things, a thermoplastic resin is particularly preferred as a material for the lens base because high productivity should be achieved in that case.

And it is especially preferred that a thermoplastic resin (such as an acrylic UV curable resin), which has a low refractive index and a high degree of wavelength dispersion, be used to make the lens base 15 and a resin material in which inorganic particles such as particles of zirconium oxide are dispersed be used as a high-refractive-index, low-wavelength-dispersion material to make the protective coating 14. By using a photocurable resin such as a UV curable rein, the material can be formed in any surface shape by either coating process or molding process. As a result, the protective coating can be formed easily. Also, the inorganic particles to disperse are preferably a colorless and transparent oxide material. Among other things, to realize a high-refractive-index, low-wavelength-dispersion protective coating, an inorganic material with a high refractive index and a low degree of wavelength dispersion is needed. Examples of such inorganic materials include yttrium oxide and aluminum oxide as well as zirconium oxide. All of these three are particularly effective. And any of these oxides may be used either by itself or in combination.

If a high-refractive-index, low-wavelength-dispersion material is used to make the lens base 15 and if a low-refractive-index, high-wavelength-dispersion material is used to make the protective coating 14, then the first group of diffraction grating portions 20 is preferably arranged so that their first and second surfaces 20a and 20b face respective directions opposite to the ones specified for the preferred embodiment described above.

Also, the diffractive imaging lens 11 of the preferred embodiment described above is used as one of the two lenses that form the imaging optical system. However, if an appropriate lens shape or diffraction grating shape is selected, the present invention is also applicable for use even in an image capture device that uses either only one lens or three or more lenses in combination.

If necessary, the surface of the diffractive imaging lens 11 of the preferred embodiment described above may be covered with an antireflective coating. Furthermore, the operating wavelength is supposed to fall within the visible radiation wavelength range of 400 nm to 700 nm in the preferred embodiment described above. However, the present invention is in no way limited to that specific preferred embodiment. Optionally, another group of diffraction grating portions could be provided for the first surface 12 of the diffractive imaging lens 11 of this preferred embodiment, too.

Furthermore, in the preferred embodiment described above, the average angle of incidence θave on the respective diffraction steps of the second surface 13 of the diffractive imaging lens 11 is supposed to be calculated by Equation (5). However, the weight could be changed by using intermediate angles of incidence as well.

### COMPARATIVE EXAMPLE 1

As Comparative Example #1, made was a diffractive imaging lens not having the protective coating 14 shown in FIG. 1 but including diffraction grating portions in the same shape as the diffraction grating portions 21 shown in FIG. 1 over the entire second surface (i.e., the side facing the image capture device). The height of the diffraction steps was set to be 0.9 μm. The diffractive imaging lens of this Comparative Example #1 had quite the same aspheric coefficient on the first surface (i.e., the side facing the subject) and the same aspheric and phase coefficients on the second surface as the counterpart 11 of the preferred embodiment described above. The image produced by using the diffractive imaging lens of this Comparative Example #1 instead of the diffractive imaging lens 11 shown in FIG. 3 was evaluated. As a result, a noticeable flare and a decrease in resolution were seen around the center of the image.

A portion of an image around its center consists of light rays with a small half angle of view ω. As described above, the luminous flux of light striking the entrance pupil of a lens is proportional to the fourth power of cos ω. That is why a light ray with a small half angle of view ω contributes much more greatly to producing an image than a light ray with a large half angle of view ω. Such a light ray with a small half angle of view ω strikes the diffraction grating portions at a relatively small angle of incidence θ. That is why looking at FIG. 6(b) showing the first-order diffraction efficiency in a situation where θ=0 degrees, it can be seen that the diffraction grating portions with no protective coating had a maximum first-order diffraction efficiency of approximately 85% and the remaining 15% was unnecessary diffracted light. Such a noticeable flare was observed with the diffractive imaging lens of Comparative Example #1 because the half angle of view ω was so small that 15% of light rays that contributed very much to producing the image would have been superposed as unnecessary diffracted light rays on the image.

### COMPARATIVE EXAMPLE 2

As Comparative Example #2, made was a diffractive imaging lens that included diffraction grating portions in the same shape as the diffraction grating portions 20 shown in FIG. 1 over the entire second surface (i.e., the side facing the image capture device) and that was covered with a protective coating having no diffraction grating portions thereon. The height of the diffraction steps was set to be 14.9 μm. The materials of the protective coating and diffraction grating portions of the diffractive imaging lens of this Comparative Example #2 were the same as what was used to make the diffractive imaging lens 11 of the preferred embodiment described above. The diffractive imaging lens of this Comparative Example #2 had quite the same aspheric coefficient on the first surface (i.e., the side facing the subject) and the same aspheric and phase coefficients on the second surface as the counterpart of the preferred embodiment described above. The image produced by using the diffractive imaging lens of this Comparative Example #2 instead of the diffractive imaging lens 11 shown in FIG. 3 was evaluated. As a result, the brightness was significantly different between central and peripheral portions of the image and the peripheral portion of the image with a large angle of view was rather dark. In addition, a noticeable flare and a decrease in resolution were also seen in the peripheral portion of the image.

A peripheral portion of an image consists of light rays, of which the absolute value of the half angle of view ω is large. Such light rays, of which the half angle of view ω has a great absolute value, will usually strike the diffraction grating portions at an angle of incidence θ with a relatively large absolute value. Among other things, steps with large diffraction step numbers in Table 1 have so small diffraction pitches that their first-order diffraction efficiency decreases as can be seen from FIGS. 7(a) and 8(a). Refraction of light that crosses high diffraction steps, as well as production of non-first-order diffracted light (i.e., diffracted light rays of unnecessary orders), would not contribute to imaging but would cause loss or stray light. Probably for that reason, a significant difference would have been caused between the central and peripheral portions of the image, the peripheral portion of the image with a large angle of view would have darkened, and a noticeable flare would have been produced in the peripheral portion of the image.

### INDUSTRIAL APPLICABILITY

The diffractive imaging lens of the present invention can form an optical system of a small number of lenses, and therefore, contributes to size reduction effectively. In addition, the lens of the present invention has a high resolution, can be used to capture an image with a bright peripheral portion in a wide range, and therefore, can be used effectively to make an image capture device. The image capture device of the present invention can be used effectively as a car camera, a surveillance camera, a medical device camera, a cellphone camera or a digital camera, to name just a few.

### REFERENCE SIGNS LIST

10 optical axis
11 diffractive imaging lens
12 first surface
13 second surface
14 protective coating
15 lens base
16 third surface
20, 21 diffraction grating portion
20a, 21a first surface
20b, 21b second surface
32 diaphragm
33 concave lens
34 cover glass plate
35 solid-state image sensor
51a chief ray with half angle of view of 75 degrees
51b light ray having half angle of view of 75 degrees and passing through upper end of diaphragm on the paper
51c light ray having half angle of view of 75 degrees and passing through lower end of diaphragm on the paper

1. A diffractive lens comprising
a lens base, one surface of which has a first aspheric shape on which a first group of diffraction steps and a first smooth surface portion are arranged in this order outward from the optical axis of the diffractive lens, and
a protective coating, which covers that surface of the lens base with the first group of diffraction steps and the first smooth surface portion and one surface of which has a second aspheric shape on which a second smooth surface portion and a second group of diffraction steps are arranged in this order outward from the optical axis of the diffractive lens,
wherein the second group of diffraction steps is arranged farther away from the optical axis, and lower in height, than the first group of diffraction steps, and
wherein one of the respective materials of the lens base and the protective coating has a higher refractive index and a greater Abbe number than the other material.

2. The diffractive lens of claim 1, wherein the first and second groups of diffraction steps have been formed based on the same phase function.

3. The diffractive lens of claim 1, wherein the farther away from the optical axis, the smaller the pitches of the first and second group of diffraction steps, and
wherein the second group of diffraction steps has a pitch of 30 μm or less.

4. The diffractive lens of claim 1, wherein the first and second groups of diffraction steps are arranged concentrically around the optical axis.

5. The diffractive lens of claim 1, wherein the lens base and the protective coating are made of resins, and
wherein inorganic particles are dispersed in at least one of the resins that make the lens base and the protective coating.

6. The diffractive lens of claim 5, wherein the protective coating is made of a photocurable resin in which particles of at least one of zirconium oxide, yttrium oxide and aluminum oxide are dispersed.

7. The diffractive lens of claim 1, wherein the farther away from the optical axis, the lower the first and second groups of diffraction steps.

8. An image capture device comprising:
an optical system including the diffractive lens of claim 1;
a solid-state image sensor for converting light that has come from a subject and has passed through the optical system into an electrical signal; and
a computing circuit for producing a subject image based on the electrical signal supplied from the solid-state image sensor.

9. A diffractive lens for use to capture an image, the lens comprising
a lens base, one surface of which has a first group of diffraction steps, and
a protective coating, which covers that surface of the lens base with the first group of diffraction steps,
wherein the protective coating has, on its surface, a second group of diffraction steps, which is arranged farther away from the optical axis of the diffractive lens, and lower in height, than the first group of diffraction steps, and
wherein one of the respective materials of the lens base and the protective coating has a higher refractive index and a greater Abbe number than the other material.

10. An image capture device comprising
an optical system including a diffractive lens, and
a solid-state image sensor for converting light that has come from a subject and has passed through the optical system into an electrical signal, and
wherein the diffractive lens includes
a lens base, one surface of which has a first group of diffraction steps, and
a protective coating, which covers that surface of the lens base with the first group of diffraction steps, and
wherein the protective coating has, on its surface, a second group of diffraction steps, which is arranged farther away from the optical axis of the diffractive lens, and lower in height, than the first group of diffraction steps, and
wherein one of the respective materials of the lens base and the protective coating has a higher refractive index and a greater Abbe number than the other material, and
wherein the solid-state image sensor receives, on the same image capturing plane, light rays that have been incident on the first and second groups of diffraction steps, respectively, and then converts the light rays into the electrical signal.
